(19) United States
(12) Patent Application Publication
(10) Pub. No.: US 2009/0308544 A1
(43) Pub. Date: Dec. 17, 2009

(54) Spacing mechanism

(75) Inventor: Yacov Ganzi, Kfar Neter (IL)

Correspondence Address: THE NATH LAW GROUP, 112 South West Street, Alexandria, VA, 22314, US

(73) Assignee: Holis Metal Industries Ltd., Afula Ilit (IL)

(21) Appl. No.: 12/213,142

(22) Filed: Jun. 16, 2008

(51) Int. Cl. E06B 9/266

(52) U.S. Cl. 160/178.1 V

(57) ABSTRACT

According to the present invention there is provided a spacing arrangement for a vertical blind system comprising a plurality of vertical slats. The spacing arrangement comprises a first strand and a second strand arranged in a bellows type configuration. Each strand is composed of a plurality of elongate spacers, each spacer having a lead end, a tail end, and a mid-point. The strands are arranged such that a lead end of one spacer is pivotally articulated to the tail end of an adjacent spacer. The first strand and the second strand are pivotally articulated to one another at a mid-point of each two intersecting spacers. At least one of the spacers is formed at its mid-point with an attachment port for receiving a vertical slat or a blind accessory formed with an attachment port for receiving the vertical slat.

### FIELD OF THE INVENTION

This invention relates to vertical blind systems, in particular, systems adapted for spacing the slats of the blind system from one another

### BACKGROUND OF THE INVENTION

Vertical blind/curtain systems are well known in the art and generally comprise a rail mounted onto a wall or ceiling, and vertical blinds articulated to a spacing arrangement adapted to travel along the rail to allow deployment or retraction of the vertical blind. The spacing arrangement usually comprises a plurality of attachment ports for attachment of the vertical blinds thereto, and is designed so as to allow variable spacing between the ports to facilitate the deployment/retraction.

The vertical blind may be of a variety of types ranging from a plurality of separate blind slats to a continuous sheet. In case a plurality of blind slats are used, each slat is adapted to be attached to a corresponding port, and in case a continuous sheet is used, a set of mounting elements is arranged at a top end thereof, each element being adapted to be attached to the corresponding attachment port.

In most vertical blind systems, it is desired that at a deployed position of the blinds, an essentially even distance between the attachment ports is maintained, for even distribution of the weight of the blinds/curtains, uniform shading, but mostly for aesthetic purposes. For this purpose, most of the vertical blind systems are designed with a maximal predetermined distance set between each two attachment ports. This distance corresponds to a predetermined length L of the rail unit so as to allow even distribution of the blinds when deployed across the entire length of the rail unit.

For better understanding of the spacing arrangement, attention is drawn to FIGS. 1A and 1B, in which a vertical blind system as known in the art, generally designated A is shown, comprising a rail unit B, a spacing arrangement C and a plurality of vertical slats D. Each vertical slat D is attached to the spacing arrangement via an attachment port E. The system itself is mounted on a wall/ceiling W.

It is observed from FIG. 1A, that when deploying the vertical blind in the direction of arrow R, the first slat D₁ first displaces to its maximal predetermined distance T, and having reached this distance, deployment of the following slat D₂ commences. In this position shown in FIG. 1A, the second slat D₂ is shown spaced at a distance T from the first slat D₁ and at a distance T′<T from the third slat D₃. The other two slats D₄ and D₅ are at a minimal predetermined distance t from one another.

Turning now to FIG. 1B, it is observed that miscalculation of the distances T between the attachment ports E of the spacing arrangement C may yield an uneven distance between the slats D. For example, in the present case, the distance between the fourth and fifth slat D₄ and D₅ is T″ such that t<T″<T′<T.

### SUMMARY OF THE INVENTION

According to the present invention there is provided a spacing arrangement for a vertical blind system comprising a plurality of vertical slats, said spacing arrangement comprising a first strand and a second strand arranged in a bellows type configuration, each strand composed of a plurality of elongate spacers, each spacer having a lead end, a tail end, and a mid-point, the strands being arranged such that a lead end of one spacer is pivotally articulated to the tail end of an adjacent spacer, wherein said first strand and said second strand are pivotally articulated to one another at a mid-point of each two intersecting spacers, at least one of said spacers being formed at its mid-point with an attachment port for receiving a vertical slat or a blind accessory formed with an attachment port for receiving said vertical slat.

The spacing arrangement is designed such that two spacers of a strand, separated therebetween by an intermediate spacer, are substantially parallel to one another.

Said spacing arrangement is displaceable between a first, fully retracted position and a second, fully deployed position. In the fully retracted position, the lead end and tail end of each spacer of said first strand are adjacent the tail end and lead end of the intersecting spacer of said second strand respectively. In other words, in the fully retracted position the midpoints of each pair intersecting spacers are adjoining each other. In the fully deployed position, the lead end and tail end of each spacer of said first strand are adjacent the lead end and tail end of the intersecting spacer of said second strand respectively. In other words, in the fully deployed position the midpoints of each pair of intersecting spacers are spaced from one another to their full extent.

The spacing arrangement may further assume a plurality of intermediate positions between said fully retracted and fully deployed position, wherein, at all the above positions, the axial distance between each two adjacent mid-points is essentially similar, i.e. the axial distance between two neighboring mid-points is determined by the respective axial span of the spacing arrangement. Such an arrangement provides that at any position assumed by the vertical blind system, the distance between each two adjacent vertical slats remains essentially similar.

Each strand may comprise male spacers and female spacers, adapted to be pivotally articulate to one another. Pivotal articulation may be achieved, for example, using a snap mechanism, in which case a male spacer is formed with snap projections at its lead end, tail end and mid-point, extending essentially perpendicular to said spacer, and a female spacer is formed with corresponding receptacles at its lead end, tail end and mid-point. Each of said receptacles may be through-going. According to this arrangement, the lead end projection of said male spacer is pivotally articulated to the tail end receptacle of its adjacent female spacer.

In the above arrangement, the two strands are connected to one another to form said spacing arrangement by the mid-point snap projection of a male spacer of said first strand being received within the mid-point receptacle of a female spacer of said second strand.

The mid-point receptacle of said female spacer may constitute an attachment port for a blind slat. Attachment of said blind slat to the female spacer may be achieved by a similar snap-type arrangement as the one used for coupling between the male and female spacers. For this purpose, said female spacer may have a sufficient thickness so as to allow said mid-point receptacle to receive a snap projection of a male spacer from one end thereof, and a snap projection of said blind slat from the other end thereof.

Optionally, said vertical blind accessory may be a blind mechanism unit, adapted for tilting the blind slat and facilitating deployment and retraction of the spacing arrangement. Each blind mechanism unit may be adapted to be attached to an attachment port of the spacing arrangement at one end thereof, and be adapted for attachment thereto of the blind slat at the other end thereof.

Each blind mechanism unit may comprise a housing formed at a top end thereof with a snap projection to be received within the corresponding mid-point receptacle of said female spacer. The housing may further be formed with a tilt mechanism portion adapted to accommodate at least a part of a tilting mechanism responsible for tilting the blind slats, and a deployment mechanism portion adapted to accommodate at least a part of a deployment mechanism responsible for deploying and retracting the blind slats.

The tilt mechanism portion of said housing may be formed with a first, central channel extending essentially along a vertical axis and adapted to receive therein a holder formed with at least a geared portion; and a second, side channel extending essentially along a horizontal axis, and adapted to receive therein a cog wheel. The cog wheel and holder are adapted to engage each other to form a tilt mechanism of the blind mechanism unit. Said cog wheel is adapted to receive therein a driving rod whereby rotation of the driving rod entails rotation of the cog wheel about the horizontal axis, and subsequent rotation of the holder about the vertical axis.

Each holder may be formed with a holder body which is an essentially hollow cylinder extending along an axis X, and corresponding in dimensions to be rotationally received within the central channel of said housing. Said holder may also have, at a top end thereof, a snap portion adapted to engage the blind mechanism snap member. The holder body may further be formed with a cog-wheel portion having teeth which extend radially about the axis X. The holder body may also be formed with a circumferential flange adapted to prevent it from disengaging from said housing, and a side slot, the purpose of which will be described in detail later.

Said pinion gear may be formed with a gear body which is optionally of cylindrical shape and essentially hollow, and having projections at a front and rear end thereof adapted to be received within corresponding receptacles of the said side channel to be rotationally received therein. The pinion gear may further be formed with gear teeth adapted to engage the cog-wheel teeth of said holder. The pinion gear may be adapted to receive a driving rod (not shown) therethrough, in such a way that rotation of the rod entails rotation of the pinion gear.

In assembly, said holder and said pinion gear are arranged within the housing such that rotation of the pinion gear about the Y axis thereof entails a corresponding rotation of the holder about the central axis X thereof.

The deployment mechanism portion of said housing may be formed with a first and a second chord channels, each of which are through going, whereby, when properly arranged, a chord may be passed through a plurality of blind mechanism units so as to allow deployment and retraction of the spacing arrangement.

Said spacing arrangement may be formed with a chord anchoring point at its second end and be fitted with a deployment chord and a retraction chord, and said rail unit may comprise a pulley wheel at an end thereof remote from the tail end of said spacing arrangement, and a chord channel at an end adjacent the tail end of said spacing arrangement.

In this case, the deployment chord may be arranged such that a first end thereof is attached to the anchoring point, the deployment chord passes around the pulley such that a second end thereof is received within the chord channel. Thus, upon pulling on the deployment chord, the lead end of said spacing arrangement is pulled towards the second end of the rail unit and the spacing arrangement is deployed. The retraction chord may be arranged such that a first end thereof is attached to the anchoring point, the retraction chord being passed towards the tail end of the spacing arrangement such that a second end thereof is received within the chord channel. Thus, upon pulling on the retraction chord, the lead end of said spacing arrangement is pulled backwards to the first end of the rail unit and the spacing arrangement is retracted.

According to a specific embodiment, both said deployment chord and said retraction chord may be adapted to pass through the blind mechanism units. For this purpose, each blind mechanism unit may be formed with chord channel.

In addition, each blind mechanism unit may further comprise a replaceable suspension member adapted for suspension of said blind slat therefrom. According to one design variation said suspension member may be integrally formed with said housing, while according to another design variation said suspension member may be adapted to be detachably attachable from said blind mechanism unit.

In the former case, said suspension member may be formed with a holder engaging portion and a slat engaging portion. Said holder engaging portion may have a body which is essentially cylindrical and having a dimension corresponding to that of the holder to allow insertion of the suspension member therein. The body may optionally further comprises a securing arm adapted to prevent disengagement of said suspension member from said holder. Said securing arm may be formed with a snap-type locking protrusion and a release stud.

In assembly, said suspension member may be removably inserted into said holder, until the locking protrusion thereof engages the slot and circumferential flange of the holder. In particular, such that a bottom surface of the locking protrusion becomes flush with a top surface of the circumferential flange so as to prevent disengagement of the suspension member from the holder under application of axial load thereto, e.g. by weight of a blind slat. In addition, further insertion of the suspension member into the holder is prevented by a top end of the holder engaging portion coming in contact with the blind mechanism snap member.

According to a design variation of the present invention, said spacing arrangement may comprise several chains, which are pivotally interconnected with one another, whereby, additional attachment ports may be formed at the articulation points between two spacing arrangements. Having a plurality of attachment ports may allow for an enormous variety of options for arranging blind mechanism units on said spacing arrangement. For example, blind mechanism units may be arranged in a zig-zag pattern or, according to another example, the blind mechanism units may be arranged in rows. This may provide forming several layers of blinds, for example, in case three layers are used, a first layer may be used for aesthetic purposes, a second layer may be used for shading and a third layer may be used as a screen for projecting an image thereon.

It should also be appreciated that according to the above arrangement, during deployment, similar to previously described examples, the width of each spacing arrangement may vary, whereby the blind mechanism units may be brought closer towards one another. In order to prevent disengagement of the blind mechanism units from the rail, the units may be provided with longer mounting protrusions.

According to a specific design variation of the present invention, said vertical blind system may comprise a continuous veil or curtain rather than separate blind slats. Said curtain may be formed with suspension loops adapted for attachment to corresponding rings of the vertical blind system. The spacing arrangement may still allow, as previously discussed, even spacing between the rings for aesthetic purposes. It should also be appreciated that according to the present design variation, the tilting mechanism previously described may still be operational. However, this is not compulsory.

According to another design variation of a vertical blind system may comprise a top rail and a bottom rail having corresponding undulating shapes. Each rail may be adapted to accommodate a spacing arrangement, to each of which, a set of blind mechanism units may be attached. Between the two rails a plurality of blind slats may be assembled. Said slats may be deployed and retracted between the two rails as previously described, however, in the present example, movement of the bottom ends of said blind slats are prevented due to their engagement with the bottom blind mechanism units.

It should also be appreciated that since the driving rod may also be made of a flexible material such as, for example, plastic, the vertical blind system may be fully provided with both an operative tilting and an operative deployment mechanism.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1A is a schematic illustration of a vertical blind system of the prior art, in a partly deployed position;

FIG. 1B is a schematic illustration of the vertical blind system shown in FIG. 1A, in a fully deployed position;

FIG. 2A is a schematic illustration of a vertical blind system according to the present invention, in a first, retracted position;

FIG. 2B is a schematic illustration of the vertical blind system shown in FIG. 2A, in a second, deployed position;

FIG. 3A is a schematic illustration of a spacing arrangement according to the present invention in the position corresponding to the position of the vertical blind system shown in FIG. 2A;

FIG. 3B is a schematic illustration of a spacing arrangement according to the present invention in the position corresponding to the position of the vertical blind system shown in FIG. 2B;

FIG. 4A is a top view of a male spacer used in the spacing arrangement shown in FIGS. 3A and 3B;

FIG. 4B is a longitudinal cross section of the male spacer shown in FIG. 4A taken along line A-A;

FIG. 4C is an enlargement of detail I of FIG. 4B;

FIG. 5A is a top view of a female spacer used in the spacing arrangement shown in FIGS. 3A and 3B;

FIG. 5B is a longitudinal cross section of the male spacer shown in FIG. 5A taken along line B-B;

FIG. 5C is an enlargement of detail II of FIG. 5B;

FIG. 6A is a schematic side section view of a strand of the spacing arrangement shown in FIG. 3A, taken along line C-C;

FIG. 6B is a schematic front view of the spacing arrangement shown in FIG. 6A;

FIG. 7A is a top view of the spacing arrangement shown in FIGS. 3A and 3B with two blind mechanism units attached thereto;

FIG. 7B is a front view of a blind mechanism unit shown in FIG. 7A;

FIG. 7C is a side view of a blind mechanism unit shown in FIG. 7B;

FIG. 8A is a side view of a holder used in the blind mechanism unit shown in FIG. 7B;

FIG. 8B is a cross-sectional side view of the holder of FIG. 8A taken along line A-A;

FIG. 8C is a cross-sectional front view of the holder of FIG. 8A taken along line D-D;

FIG. 9A is a side view of a slat suspension member used in conjunction with the blind mechanism unit shown in FIG. 7B;

FIG. 9B is a longitudinal cross-sectional view of the slat suspension member shown in FIG. 9A taken along line A-A;

FIG. 9C is a top view of the slat suspension member shown in FIG. 9A;

FIG. 9D is an enlarged view of detail III of FIG. 9B;

FIG. 10A is a schematic front sectional view of the spacing arrangement and blind mechanism unit shown in FIGS. 6A to 7C when housed within a rail of the blind system shown in FIGS. 2A and 2B;

FIG. 10B is an enlarged view of a portion of the rail unit and spacing arrangement shown in FIG. 10A according to another embodiment of the present invention;

FIG. 11 is a schematic cross-sectional view of the blind system shown in FIG. 1 with a pulley arrangement;

FIG. 12 is a schematic illustration of a vertical blind system according to another embodiment of the present invention comprising a continuous curtain;

FIG. 13 is a schematic illustration of a vertical blind system according to a further embodiment of the present invention; and

FIG. 14 is a spacing arrangement according to another embodiment of the present invention.

### DETAILED DESCRIPTION OF EMBODIMENTS

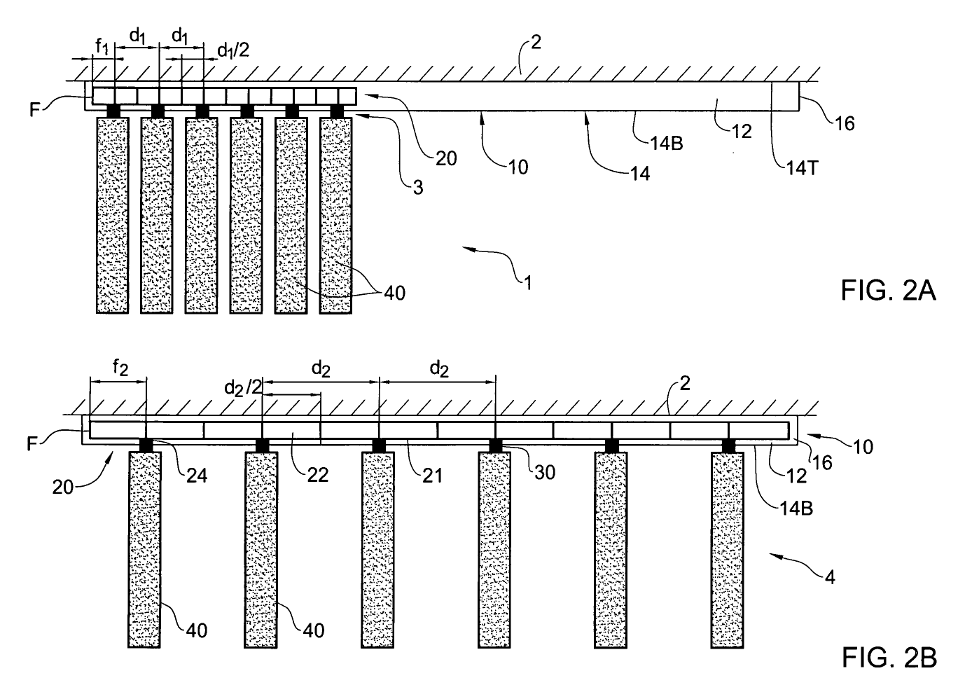

With reference to FIG. 2A, a vertical blind system generally designated 1 is shown comprising a rail unit 10, a spacing arrangement 20, a plurality of blind mechanism units 30 constituting a blind mechanism 3, and a plurality of blind slats 40 constituting a vertical blind set 4.

In assembly, the vertical blind system 1 is suspended from a top wall 2, which may be a ceiling, a window ledge etc. by its rail unit 10. The spacing arrangement 20 is freely confined within the rail unit 10, each of the blind mechanism units 30 of the blind mechanism 3 is articulated to the spacing arrangement 20, and a blind slat 40 is mounted onto each of the blind mechanism units 30.

The rail unit 10 comprises an elongated body constituting a housing 12 formed with a top, mounting wall 14T, side walls 14S and a bottom, blind wall 14B, together defining a central cavity 16. The bottom wall 14B of the housing 12 is further formed with an elongated blind mechanism slot 18. The mounting wall 14T is adapted for mounting the entire blind system 1 onto the top wall 2, the cavity 16 is adapted for receiving therein the spacing arrangement 20, and the blind mechanism slot 18 is adapted to allow a part of the blind mechanism 30 to protrude from the housing 12 when articulated to the spacing arrangement 20 as described above.

The spacing arrangement comprises a variable length spacing chain 21 made of a plurality of spacer units 22 (hereinafter ‘spacers’), and a plurality of attachment ports 24, each being adapted for connection thereto of a blind mechanism unit 30. Due to the design of the spacing chain 21, the spacing arrangement 20 may assume a variety of positions ranging between a fully retracted position and a fully deployed position. The spacing arrangement 20 is designed such that at any given position, the distances between each two adjacent attachment ports 24 are essentially the same.

With further reference to FIG. 2A, the vertical blind system 1 is shown in a retracted position, and it is observed that the distances d₁ between each two attachment ports 24, and consequently between each two blind mechanism units 30 and blind slats 40 are essentially the same. With reference now to FIG. 2B, the vertical blind system 1 is shown in an intermediate position, where the attachments ports 24 of the spacing arrangement 20 are farther apart from one another at a distance d₂. However, it is observed that nonetheless, the same distance d₂ exists between each two attachment ports 24.

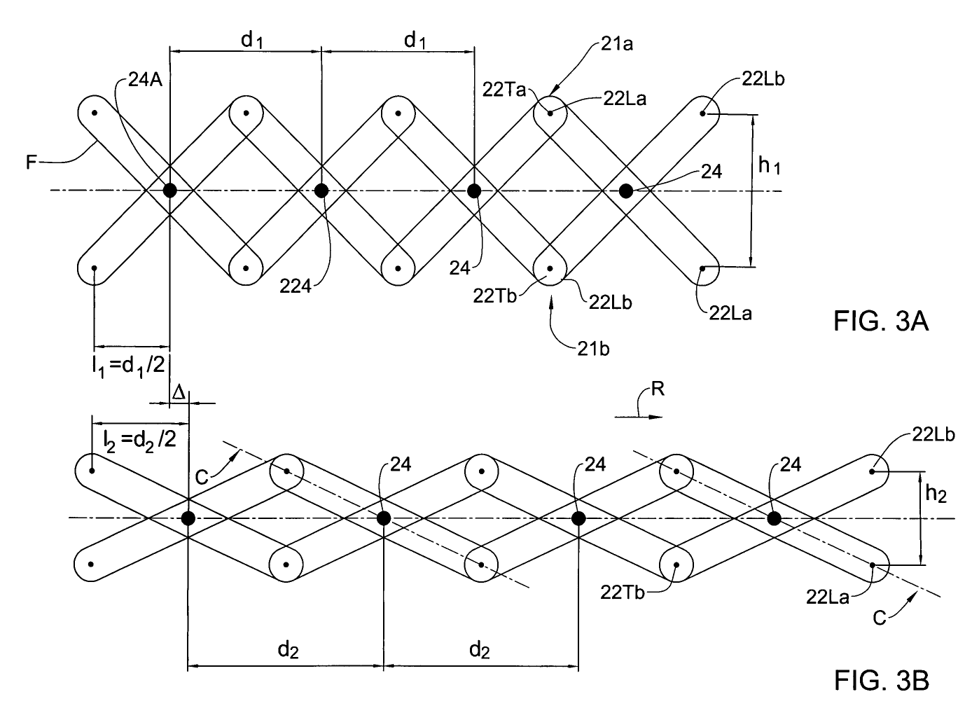

Attention is now drawn to FIGS. 3A and 3B, in which the spacing arrangement 20 is shown in two different deployment positions. The spacing arrangement 20 is formed of a chain 21 comprising a first and a second strand 21a and 21b respectively. Each strand 21a, 21b is made of a plurality of spacers 22a and 22b respectively, each spacer having a lead end 22L, a tail end 22T and a mid-point 22M. Each strand 21a, 21b is arranged such that the spacers 22 thereof are pivotally articulated lead end 22L to tail end 22T. In addition, the strands 21a, 21b are pivotally connected to one another via the mid-points 22M of corresponding spacers 22. This arrangement yields an accordion-like shape of the spacing arrangement 20, allowing it to expand and retract.

In the vertical blind system 1, the spacing arrangement 20 is arranged such that one end of the chain 21 is fixed to the rail at point F. With particular reference to FIG. 3A, it is observed that the distance between the first attachment port 24a from the fixed point F equals l₁=d₁/2. All the attachment ports 24 are equally spaced from one another as shown in FIG. 2A. When changing the position of the vertical blinds to the position shown in FIG. 2B and FIG. 3B, the first attachment port 24a is displaced farther from the fixed point F by Δ, to a distance l₂=d₂/2, while the attachment ports 24 remain equally spaced, however, with a greater spacing d₂.

It should thus be understood that at any position of the vertical blinds, the distance between each to adjacent attachment ports 24 is essentially the same, regardless of the length L of the rail 10. This eliminates the need for predetermined matching the number of blind slats 40, and the maximal distance between each two slats according to the available rail length L.

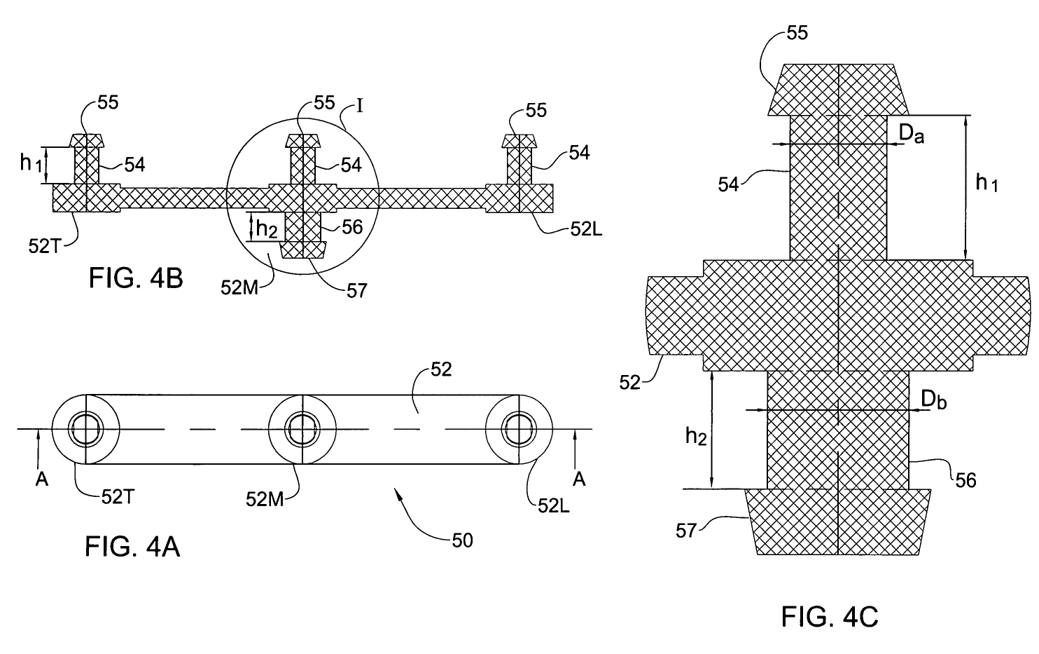

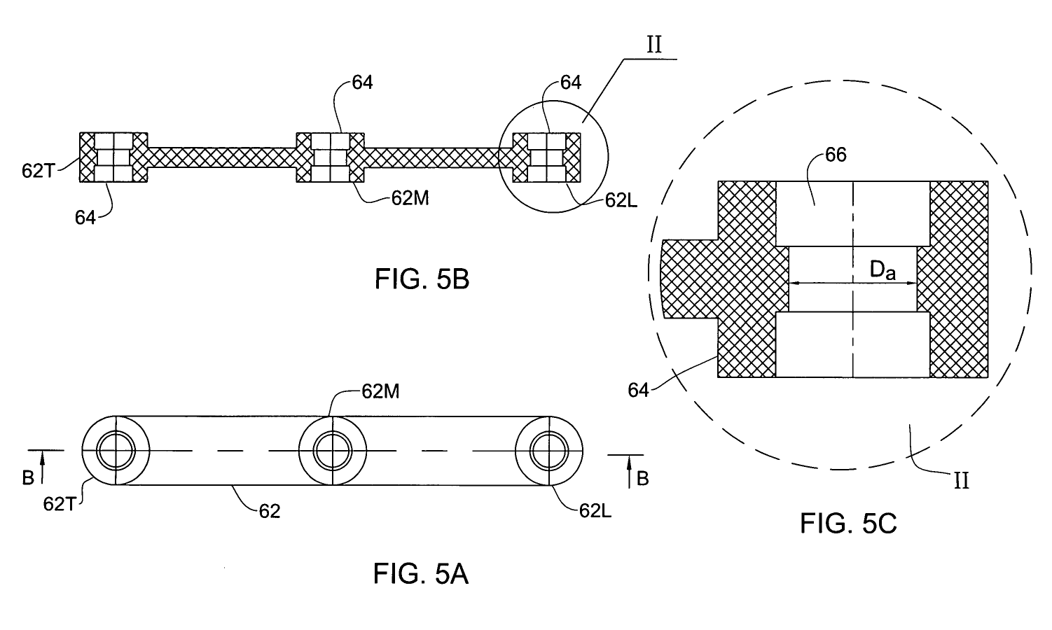

According to a specific embodiment of the invention, the chain 21 itself is made of male spacers 50 (shown FIGS. 4A to 4C) and female spacers 60 (Shown FIGS. 5A to 5C).

With reference to FIGS. 4A to 4C, each male spacer 50 has a prolonged body 52, having a lead end 52L a tail end 52T, and a mid-point 52M. Each of the ends 52L, 52T and the mid-point 52M is formed with a spacer snap member 54, extending essentially perpendicular to the body 52, having at its tip a snap cap 55. The body 52 is further formed with a blind mechanism snap member 56, having a snap cap 57 at its tip. Each spacer snap member 54 has a diameter Da, and an extension h₁ perpendicular to the body 52, and the blind mechanism snap member 56 has a diameter Db>Da and an extension h₂ perpendicular to the body 52.

With reference to FIGS. 5A to 5C, each female spacer 60 has a prolonged body 62, having a lead end 62L a tail end 62T, and a mid-point 62M. Each of the ends 52L, 52T and the mid-point 52M is formed with a spacer attachment port 64. Each spacer attachment port 64 is in the form of a receptacle 66 having a diameter Da corresponding to the diameter Da of the spacer snap member 54 of the male spacer 50.

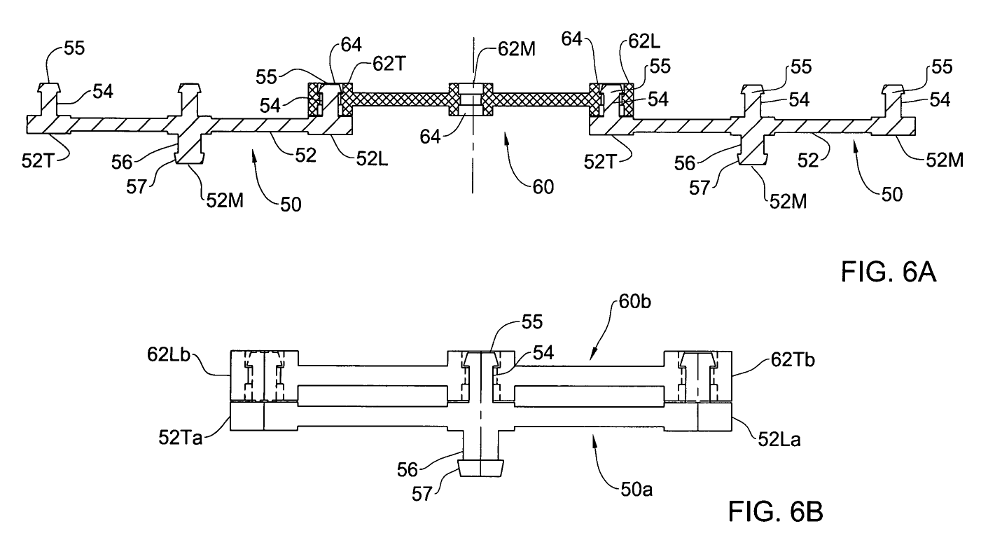

With reference to FIGS. 6A and 6B, the spacers 50, 60 of the chain 21 are arranged such that each male spacer 50 is articulated at its tail end 52T to the lead end 62L of an adjacent female spacer 60 on a left side thereof, and at its lead end 52L to the tail end 62T of an adjacent female spacer 60 on a right side thereof to for a strand 21a, 21b. Hereinafter, spacers 50, 60 of the first strand 21a are designated 50a and 60a respectively, and spacers 50, 60 of the second strand 21b are designated 50b and 60b respectively.

In the assembled position of the chain 21, the male spacers 50 are arranged such that the blind mechanism snap members 56 protrude from the chain 21, providing attachment thereto of the blind mechanism units 30.

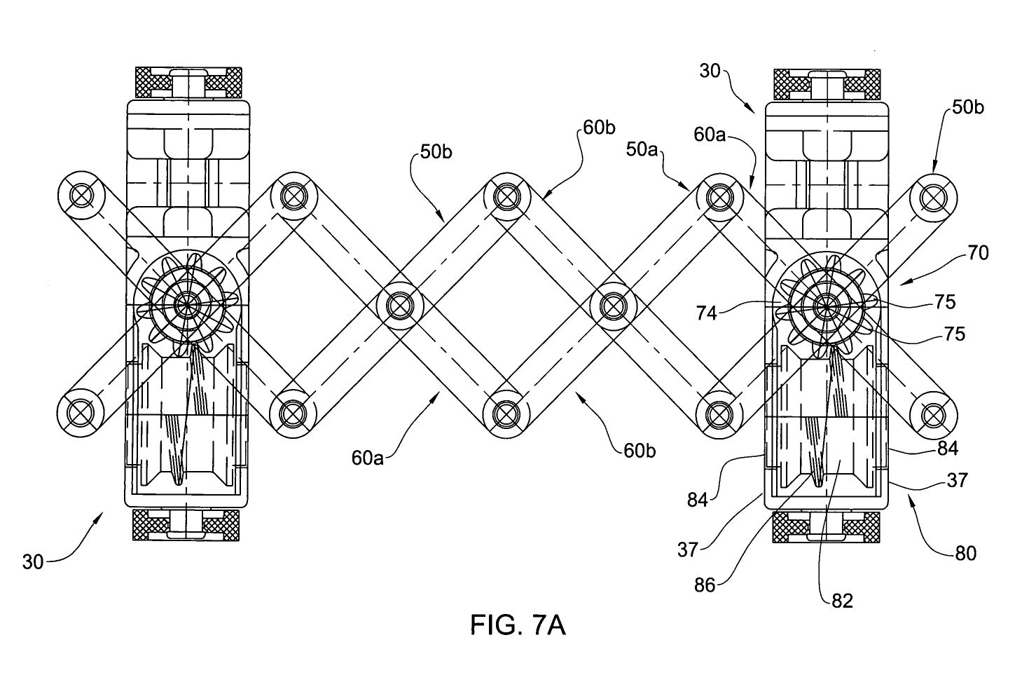

Turning now to FIGS. 7A to 7C, each blind mechanism unit 30 comprises a housing 32 having a tilt mechanism portion 32a and a deployment mechanism portion 32b. At the tilt mechanism portion 32a, the housing 32 is formed with a first, central channel 34 extending along the vertical dimension, adapted for rotationally receiving therein a holder 70, and a second, side channel 36 extending along the axial direction, adapted for receiving therein a pinion gear 80. The holder 70 and pinion gear 80 are adapted to engage each other, to thereby constitute a tilting mechanism 90 of blind mechanism unit 30. At the deployment mechanism portion 32b, the housing 32 is formed with a first chord channel 35, and a second chord channel 37 adapted to receive a tension chord (not shown) therethrough to facilitate deployment and retraction of the spacing arrangement 20.

The housing is further formed with two mounting protrusions 38 at two sides thereof, each mounting protrusion 38 receiving thereon a mounting ring 39, allowing mounting of the blind mechanism unit 30 into a rail unit 10 of the vertical blind system 1.

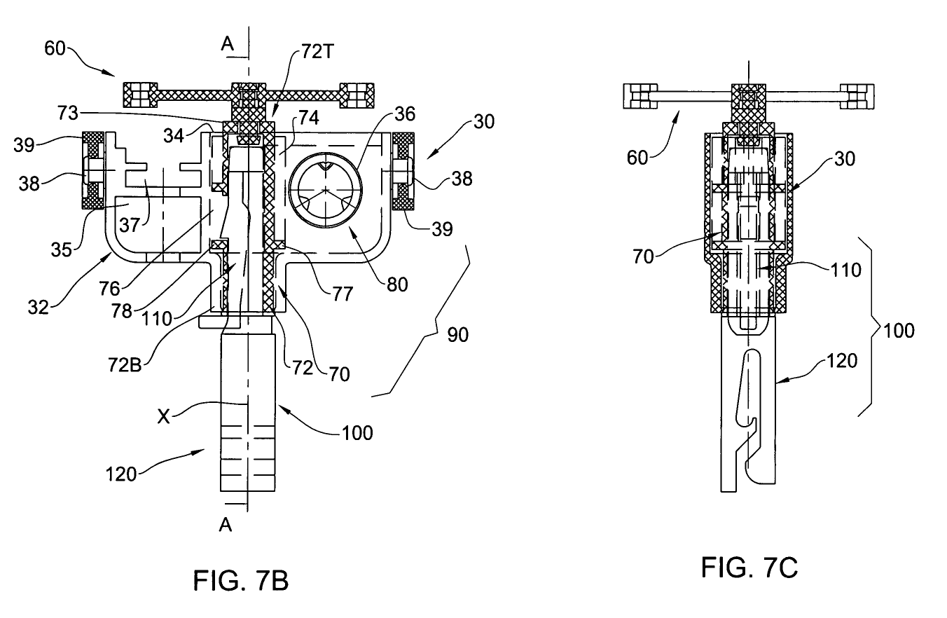

Reverting back to the tile mechanism 90, and with reference to FIGS. 8A to 8C, the holder 70 is formed with a holder body 72 which is an essentially hollow cylinder extending along a central axis X, and corresponding in dimensions to be rotationally received within the central channel 34, and has at a top end 72T thereof with a snap portion 73 adapted to engage the blind mechanism snap member 56. The holder body 72 is further formed with a cog-wheel portion 74, such that the teeth 75 thereof extend radially about the central axis X. The holder body 72 is also formed with a circumferential flange 77 adapted to prevent it from disengaging from the housing 32 of the blind mechanism unit 30, and a side slot 76, the purpose of which will be described in detail later.

The pinion gear 80 is formed with a gear body 82 which is optionally of cylindrical shape and is essentially hollow, and having projections 84 at a front and rear end thereof adapted to be received within corresponding holes of the housing 32 to be rotationally received therein. The pinion gear 80 is further formed with gear teeth 86 adapted to engage the cog-wheel teeth 75 of the holder 70. The pinion gear 80 is adapted to receive a driving rod (not shown) therethrough, in such a way that rotation of the rod entails rotation of the pinion gear 80.

In assembly, the holder 70 and pinion gear 80 are arranged within the housing 32 such that rotation of the pinion gear 80 about the Y axis thereof entails a corresponding rotation of the holder 80 about the central axis X thereof.

With particular reference being made now to FIGS. 7B and 7C, the holder 70, being essentially hollow, is adapted to receive therein a suspension member 100, formed with a holder engaging portion 110 and a slat engaging portion 120.

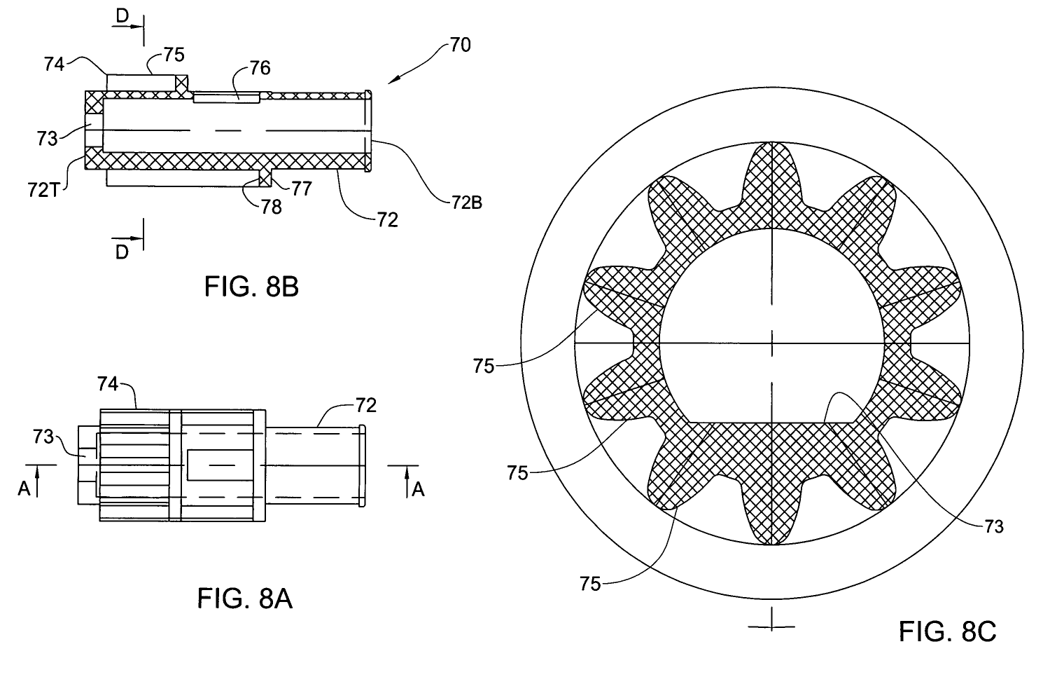

With attention being drawn now also to FIGS. 9A to 9D, the holder engaging portion 110 of the slat suspension member 100 has a body 112 which is essentially cylindrical and having a dimension corresponding to that of the holder 70 to allow insertion of the suspension member 100 therein. The body 112 further comprises a securing arm 115, formed with a snap-type locking protrusion 116 and a release stud 118.

In assembly, the suspension member 100 is inserted into the holder 70, until the locking protrusion 116 thereof engages the slot 76 and circumferential flange 77 of the holder 70. In particular, the bottom surface 117 of the locking protrusion becomes flush with the top surface 78 of the circumferential flange 77 so as to prevent disengagement of the suspension member 100 from the holder 70 under application of axial load thereto, e.g. by weight of a blind slat. In addition, further insertion of the suspension member 100 into the holder 70 is prevented by the top end 112T of the holder engaging portion 110 coming in contact with the blind mechanism snap member 56.

The blind slat engaging portion 120 of the suspension member 100 is formed with a body 121 having a central slot 121a, dividing the body 121 into a right suspension arm 122 and a left suspension arm 124. The right arm 122 is formed with a fastening projection 126 and the left arm is formed with a hook 128, the arm 122, 124 being adapted to work in conjunction with one another to allow suspension of a blind slat therefrom.

The slat engaging portion 120 of the suspension member 100 is adapted to engage a blind slat 40 formed with a suspension portion 42 having a suspension loop 44. The blind slat 40 may be forced into the slot 121a until the hook 128 hooks the suspension loop 42. In this position, the fastening projection 126 presses against the suspension portion 42 of the slat 40 due to the elasticity of the arm 122.

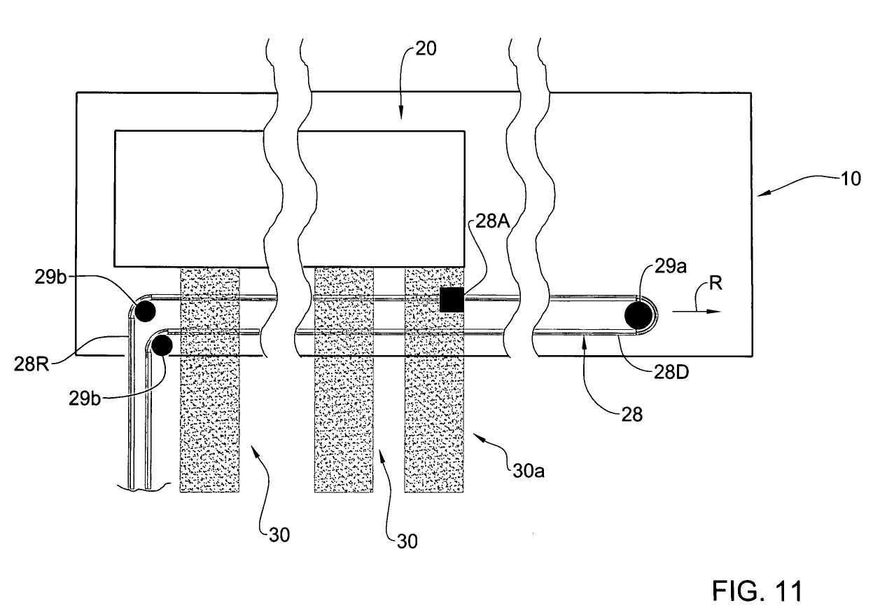

Turning to FIG. 12, when assembling the vertical blind system 1, first a desired number of blind mechanisms unit 30, each accommodating therein the holder 70 and cog wheel 80, are attached to the blind mechanism snap members 56 of the spacing arrangement 20. Thereafter, the spacing arrangement 20 with the blind mechanism units 30 mounted thereof are inserted into the rail unit 10, usually through one of the ends thereof, and the spacing arrangement 20 is fixed at a first end thereof at point F. Thereafter, each blind mechanism unit 30 receives therein a suspension member 100 therein. Finally, blind slats are attached to each of the blind suspension members 100.

Once assembled, a driving rod (not shown) is passed through the cog wheels 80 of all mechanism units 30 to allow rotation of the cog wheels and activation of the tilt mechanism 90. In addition, a tension chord is passed through the first chord channels 35 of all blind mechanism units 30 and reconnected to the rail to allow deployment of the spacing arrangement 20.

It should naturally be understood that the order of all steps described above is interchangeable.

In the assembled position, the mounting rings 39 of each blind mechanism unit 30 rest on the inner, top surfaces 15 of the bottom walls 14B of the rail unit 10, preventing disengagement of the spacing arrangement therefrom. The housing 12 of the rail unit 10 is of such dimensions so as to house therein the spacing arrangement 20 without it touching the top wall 14T of the housing 12.

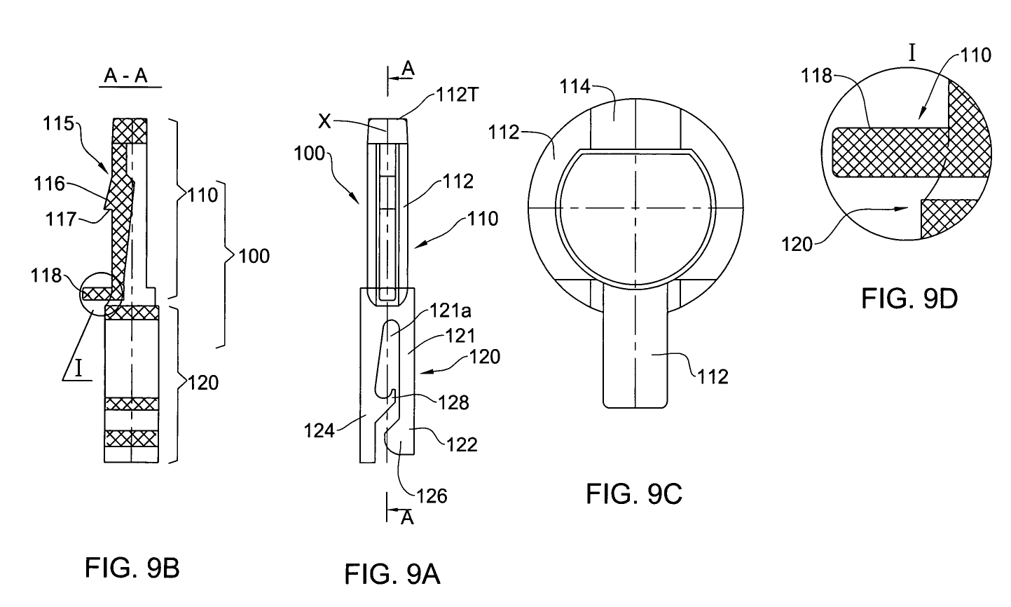

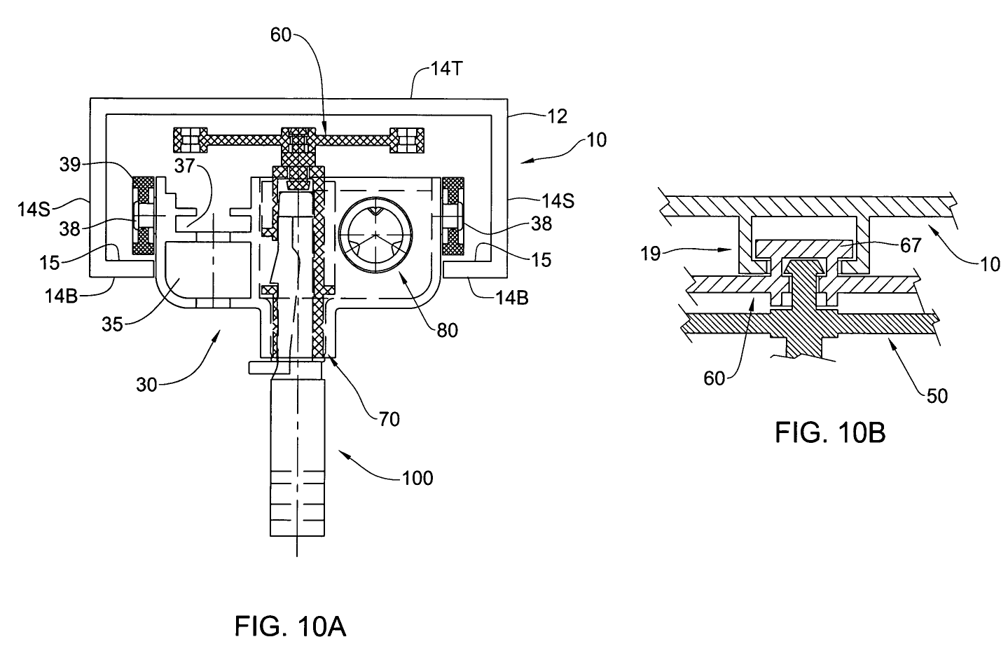

According to a particular design embodiment shown in FIG. 10B, the top wall 14T of the housing 12 is formed with a guide rail 19 of similar cross section as that of the rail unit 10 itself, and each female spacer 60 of the spacing arrangement 20 is formed with a flanged top 67 adapted to engage the guide rail 19 in a sliding manner. Such an engagement may also provide, other than further prevention of the spacing arrangement 20 from disengaging the rail unit 10, providing a desired deployment path for the spacing arrangement.

For example, although the rail unit 10 may be essentially straight, the guide rail 19 may be of an undulating shape, causing the spacing arrangement 20 to assume a corresponding undulating shape during deployment thereof, thereby adding to the aesthetic value of the vertical blind mechanism 1. It should be appreciated that assuming an undulating shape by the spacing arrangement 20 is greatly assisted by the spacing arrangement being made of a plastic material, allowing it to deform to a certain extent which is enough to provide the spacing arrangement 20 with the desired shape.

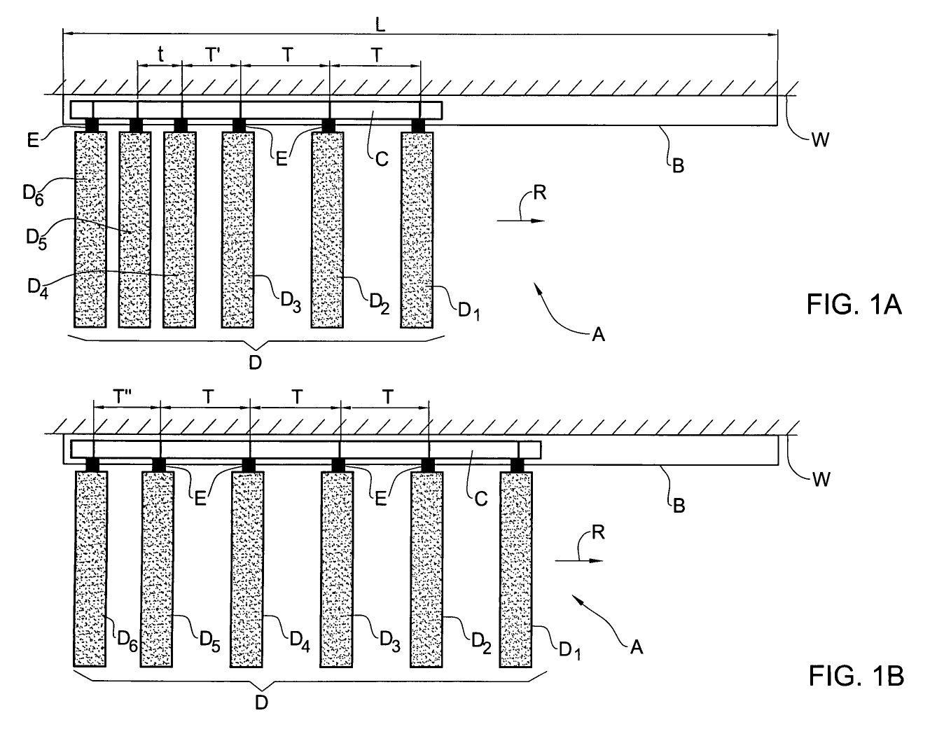

Turning now to FIG. 1, the spacing arrangement 20 and the blind mechanism units 30 are fitted with a tension chord 28, a first pulley 29a located at the end of the rail unit 10 facing the lead end 21L of the spacing arrangement 20, and two second pulleys 29b located at the end of the rail unit 10 facing the tail end 21T of the spacing arrangement 20.

The tension chord has a first deployment portion 28D, and a second retraction portion 28R. The arrangement is such that the tension chord 28 runs over the second pulley 29b, through the chord channel 35 of each blind mechanism unit 30 around the first pulley 29a and back through the chord channels 35 to go over the second pulley 29b. The tension chord is fixed at the first blind mechanism unit 30a, defining the deployment portion 28D and the retraction portion 28R. The ends of both deployment and retraction chords 28D, 28R respectively are passed through a chord channel 17 of the rail unit 10 formed adjacent the tail end 21T of the spacing arrangement 20.

In operation, starting from the retracted position, upon pulling on the deployment portion 28D of the tension chord 28, the lead end of the spacing arrangement 20 is pulled forward in direction of arrow R shown in FIG. 2A to deploy the spacing arrangement 20. Pulling on the retraction portion 28R of the tension chord 20 entails retraction of the spacing arrangement 20 back to the retracted position.

It should again be stressed that at any given position between the fully retracted to the fully deployed one, the spacing between each two attachment ports 24, and consequently between each two blind slats 40 is the same. This is of course the case if the blind mechanism units 30 are initially attached to the attachment ports 24 at equal spaces, e.g. to every attachment port 24, to every alternate attachment port 24, etc.

Turning now to FIG. 12, a vertical blind system generally designated 1′ is shown according to a design variation of the present invention, according to which the blind slats have been replaced with a continuous veil or curtain 140. The curtain 140 is formed with suspension loops 144 adapted to be attached to corresponding rings 130 of the vertical blind system 1′. The spacing arrangement 20 allows, as previously discussed, even spacing between the rings 130 for aesthetic purposes. It should also be appreciated that according to the present design variation, the tilting mechanism previously described is not compulsory.

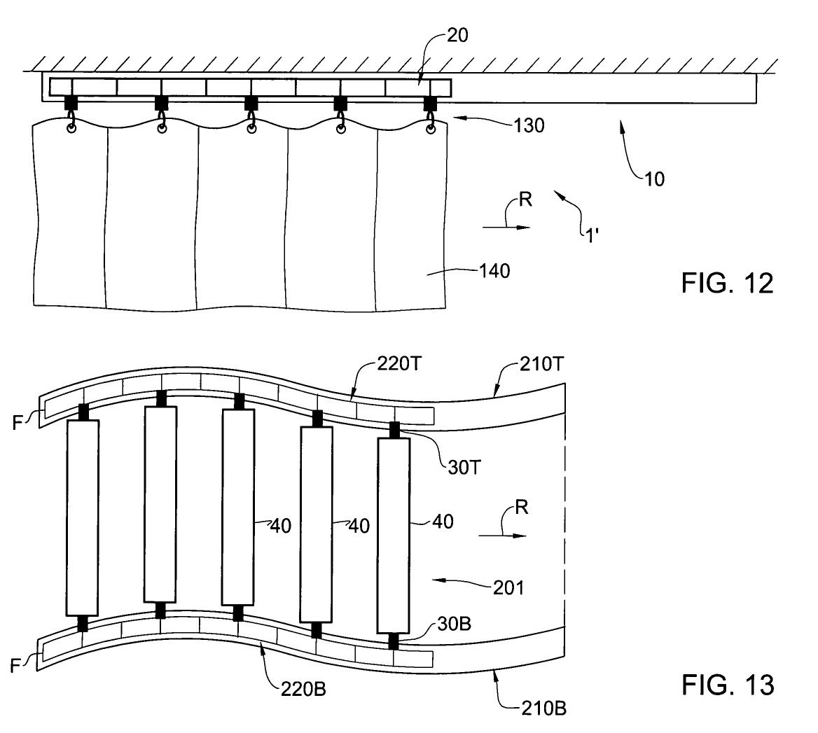

Turning to FIG. 13, according to another design variation of a vertical blind system 201 is shown comprising a top rail 210T and a bottom rail 210B, having corresponding undulating shapes. Each rail accommodates a spacing arrangement 220T, 220B respectively, to each of which, a set of blind mechanism units 30T, 30B is attached respectively. Between the two rails 210T, 210B, a plurality of blind slats 40 assembled. The slats 40 may be deployed and retracted between the two rails 210T, 210B as previously described with respect to the vertical blind system 1, however, in the present example, swinging of the bottom ends of the blind slats 40 is prevented due to their engagement with the bottom blind mechanism units 30T.

It should also be appreciated that since the driving rod may also be made of a flexible material such as, for example, plastic, the vertical blind system 201 may be fully provided with both an operative tilting and an operative deployment mechanism.

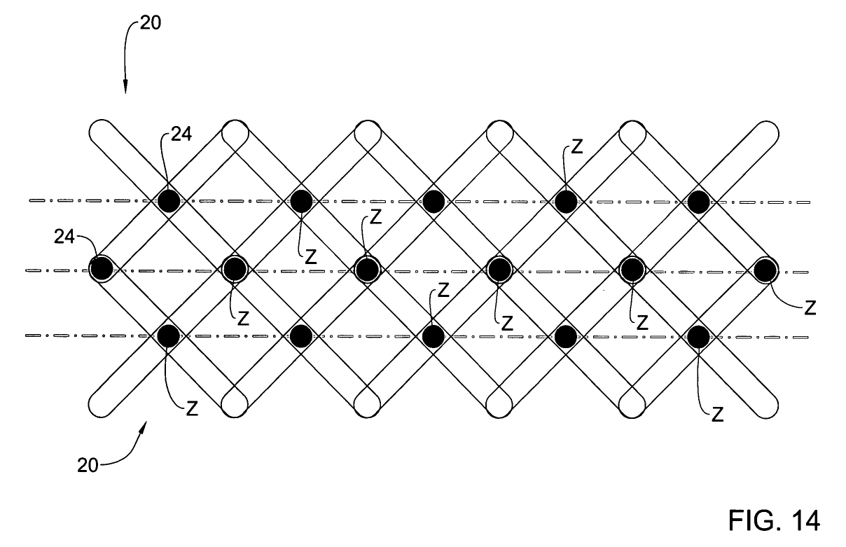

Turning now to FIG. 14, it should be understood that several spacing arrangements 20 may be pivotally articulated to one another, whereby several rows of attachment ports 24 are formed, i.e. an additional row of attachment ports 24 is formed, defined by the articulation points between the first and second spacing arrangement. Having a plurality of attachment ports allows an enormous variety of options for arranging blind mechanism units 30 and blind slats 40 thereon.

According to one example, the blind slats 40 may be arranged in a zig-zag pattern denoted by ports marked Z. According to another example, the blind slats 40 may be arranged in three rows, in which case all attachment ports 24 are occupied by blind mechanism units 30.

It should also be appreciated that according to the above arrangement, during deployment, similar to previously described examples, the width of each spacing arrangement 20 changes, whereby the blind mechanism units 30 are brought closer towards one another. In order to prevent disengagement of the blind mechanism units 30 from the rail 10, the units 30 may be provided with longer mounting protrusions.

Those skilled in the art to which this invention pertains will readily appreciate that numerous changes, variations, and modification can be made without departing from the scope of the invention, mutatis mutandis.

1. A spacing arrangement for a vertical blind system comprising a plurality of vertical slats, said spacing arrangement comprising a first strand and a second strand arranged in a bellows type configuration, each strand composed of a plurality of elongate spacers, each spacer having a lead end, a tail end, and a mid-point, the strands being arranged such that a lead end of one spacer is pivotally articulated to the tail end of an adjacent spacer, wherein said first strand and said second strand are pivotally articulated to one another at a mid-point of each two intersecting spacers, at least one of said spacers being formed at its mid-point with an attachment port for receiving a vertical slat or a blind accessory formed with an attachment port for receiving said vertical slat.

2. A spacing arrangement according to claim 1, wherein said spacing arrangement is designed such that two spacers of a strand, separated therebetween by an intermediate spacer, are substantially parallel to one another.

3. A spacing arrangement according to claim 1, wherein said spacing arrangement is displaceable between a first, fully retracted position and a second, fully deployed position.

4. A spacing arrangement according to claim 3, wherein in said fully retracted position, the lead end and tail end of each spacer of said first strand are adjacent the tail end and lead end of the intersecting spacer of said second strand respectively.

5. A spacing arrangement according to claim 3, wherein in said fully retracted position, the midpoints of each pair of intersecting spacers are adjoining each other.

6. A spacing arrangement according to claim 3, wherein in said fully deployed position, the lead end and tail end of each spacer of said first strand are adjacent the lead end and tail end of the intersecting spacer of said second strand respectively.

7. A spacing arrangement according to claim 3, wherein in said fully deployed position, the midpoints of each two intersecting spacers are spaced from one another to their full extent.

8. A spacing arrangement according to claim 3, wherein said spacing arrangement is adapted to assume a plurality of intermediate positions between said fully retracted and fully deployed position.

9. A spacing arrangement according to claim 8, wherein, at all the above positions, the axial distance between two neighboring mid-points is determined by the respective axial span of the spacing arrangement.

10. A spacing arrangement according to claim 9, wherein at any position assumed by said vertical blind system, the distance between each two adjacent vertical slats remains essentially similar.

11. A spacing arrangement according to claim 1, wherein each strand comprises male spacers and female spacers, adapted to be pivotally articulate to one another.

12. A spacing arrangement according to claim 11, wherein pivotal articulation is achieved using a snap-type mechanism.

13. A spacing arrangement according to claim 12, wherein a male spacer is formed with snap projections at its lead end, tail end and mid-point, extending essentially perpendicular to said spacer, and a female spacer is formed with corresponding receptacles at its lead end, tail end and mid-point.

14. A spacing arrangement according to claim 13, wherein two strands are connected to one another to form said spacing arrangement by the mid-point snap projection of a male spacer of said first strand being received within the mid-point receptacle of a female spacer of said second strand.

15. A spacing arrangement according to claim 1, wherein said mid-point constitutes an attachment port for said blind slat.

16. A spacing arrangement according to claim 13, wherein attachment of said blind slat to the female spacer is achieved by a similar snap-type arrangement as the one used for coupling between the male and female spacers.

17. A spacing arrangement according to claim 16, wherein said female spacer has sufficient thickness so as to allow said mid-point receptacle to receive a snap projection of a male spacer from one end thereof, and a snap projection of said blind slat from the other end thereof.

18. A spacing arrangement according to claim 1, wherein said vertical blind accessory is a blind mechanism unit adapted for tilting said blind slat and facilitating deployment and retraction of the spacing arrangement.

19. A spacing arrangement according to claim 18, wherein each blind mechanism unit is adapted to be attached to an attachment port of the spacing arrangement at one end thereof, and be adapted for attachment thereto of the blind slat at the other end thereof.

20. A spacing arrangement according to claim 18, wherein each blind mechanism unit may comprises a housing formed at a top end thereof with a snap projection to be received within a corresponding mid-point receptacle of said spacing arrangement.

21. A spacing arrangement according to claim 20, wherein said housing is formed with a tilt mechanism portion adapted to accommodate at least a part of a tilting mechanism responsible for tilting the blind slats, and a deployment mechanism portion adapted to accommodate at least a part of a deployment mechanism responsible for deploying and retracting the blind slats.

22. A spacing arrangement according to claim 21, wherein said tilt mechanism portion is formed with a first, central channel extending essentially along a vertical axis and adapted to receive therein a holder formed with at least a geared portion; and a second, side channel extending essentially along a horizontal axis, and adapted to receive therein a cog wheel.

23. A spacing arrangement according to claim 22, wherein said cog wheel and holder are adapted to engage each other to form a tilt mechanism of the blind mechanism unit.

24. A spacing arrangement according to claim 22, wherein said cog wheel is adapted to receive therein a driving rod whereby rotation of the driving rod entails rotation of the cog wheel about the horizontal axis, and subsequent rotation of the holder about the vertical axis.

25. A spacing arrangement according to claim 21, wherein said deployment mechanism portion is formed with a first and a second chord channels, each of which are through going, whereby, when properly arranged, a chord may be passed through a plurality of blind mechanism units so as to allow deployment and retraction of the spacing arrangement.

26. A spacing arrangement according to claim 18, wherein each blind mechanism unit further comprises a replaceable suspension member adapted for suspension of said blind slat therefrom.

27. A spacing arrangement according to claim 1, wherein said vertical blind system further comprises a rail unit, and wherein said spacing arrangement is formed with a chord anchoring point at its second end and fitted with a deployment chord and a retraction chord, and said rail unit comprises a pulley wheel at an end thereof remote from the tail end of said spacing arrangement, and a chord channel at an end adjacent the tail end of said spacing arrangement.

28. A spacing arrangement according to claim 27, wherein said vertical blind accessory is a blind mechanism unit adapted for tilting said blind slat and facilitating deployment and retraction of the spacing arrangement, and wherein both said deployment chord and said retraction chord are adapted to pass through the blind mechanism units.

29. A spacing arrangement according to claim 1, wherein said spacing arrangement comprises several strands, which are pivotally interconnected with one another, whereby additional attachment ports may be formed at the articulation points between two spacing arrangements.

30. A spacing arrangement according to claim 29, wherein said attachment ports are arranged so as to allow said plurality of blind slats to be arranged in more than one row.

31. A spacing arrangement according to claim 30, wherein said blind slats are arranged in three rows, a row being used for aesthetic purposes, a second row being used for shading and a third row being used as a screen for projecting an image thereon.

32. A spacing arrangement according to claim 1, wherein said vertical blind system comprises a continuous veil/curtain instead of separate blind slats.

33. A spacing arrangement according to claim 1, wherein said vertical blind system comprises a top rail and a bottom rail having corresponding undulating shapes, each rail being adapted to accommodate a spacing arrangement.

34. A spacing arrangement according to claim 33, wherein a plurality of blind slats are assembled so as to extend between the spacing arrangement of said top rail and the spacing arrangement of said bottom rail.
